(19) United States
(12) Patent Application Publication
(10) Pub. No.: US 2025/0207961 A1
(43) Pub. Date: Jun. 26, 2025

(54) METHOD AND SYSTEM FOR MEASURING HORIZONTAL TWO-PHASE GAS-LIQUID FLOW CHARACTERISTICS BASED ON SIGNALS FROM PIEZOELECTRIC PRESSURE SENSORS AND STRUCTURAL VIBRATION

(71) Applicants: PETRÓLEO BRASILEIRO S.A. – PETROBRAS, Rio de Janeiro (BR); UNIVERSIDADE ESTADUAL DE CAMPINAS, Campinas (BR)

(72) Inventors: Daniely AMORIM DAS NEVES, Goianesia (BR); Saon CRISPIM VIEIRA, Santos (BR); Adriano TODOROVIC FABRO, Brasilia (BR); Juliana RANGEL CENZI, Jacarei (BR); Bernardo PEREIRA FORESTI, Paulinia (BR); Marcelo SOUZA DE CASTRO, Campinas (BR)

(21) Appl. No.: 18/986,774

(22) Filed: Dec. 19, 2024

(30) Foreign Application Priority Data
Dec. 22, 2023 (BR) 1020230272495

(51) Int. Cl. G01F 1/74; G01D 21/02; G01F 1/34

(52) U.S. Cl. CPC G01F 1/74; G01D 21/02; G01F 1/34

(57) ABSTRACT

The present disclosure refers to embodiments of a method and a system for identifying flow patterns and characterizing the slug pattern through structural pressure and vibration signals for internal liquid-gas flow, comprising, in the case of acceleration sensors, that they are non-invasive and non-intrusive sensors that are easy to install and maintain, while the pressure sensors are also non-intrusive, easy to install and maintain, and are often already present in the pipelines. It is noted that both sensors are suitable for large-scale automation in industry. In an embodiment, the method includes, in the first step, the acquisition of pressure and acceleration signals, then the signal processing in which different techniques are used, which make it possible to identify the flow pattern and the parameters of the intermittent pattern: translation slug velocity and frequency.

### FIELD OF THE DISCLOSURE

The present disclosure relates to the field of mechanical engineering, specifically fluid mechanics, and wave propagation, aiming to obtain, indirectly, characteristics of a two-phase flow from non-invasive sensors, such as flow rate patterns, frequency, and velocity. More specifically, the present disclosure is related to indirect approaches to identify the two-phase flow pattern and, subsequently, to estimate the parameters of intermittent flow in horizontal pipelines through non-invasive and non-intrusive structural vibration measurements and through non-invasive dynamic pressure signals. More specifically, this disclosure can be used in industrial applications in which multiphase flows are present, such as oil and gas transportation pipeline in the petrochemical industry, cooling systems in the chemical industry, in processes in the food industry, such as the production of stable emulsions, among others.

### BACKGROUND OF THE DISCLOSURE

Two-phase flow is a challenging phenomenon in many industrial applications, since it has different geometric and spatial distributions between phases, called flow patterns, which have distinct structural loading characteristics. It is extremely important to identify and characterize the different flow patterns of the system for the optimization and safety of the processes involved. Several sensing and monitoring techniques have been developed for pipeline systems, and the main ones involve intrusive sensors, such as electrical, capacitive, or inductive sensors. These are unfeasible for industrial applications, as these environments have a high degree of danger, being places of difficult access, with high temperatures and high pressure. In addition, there are techniques that use a high-speed camera to identify the flow pattern; however, it is a subjective technique that is not feasible in industrial applications, as they require a transparent pipe section that allows visualization of the internal flow, and also accessibility to the measurement site.

Other solutions involve non-invasive ultrasonic sensors that work on the principles of reflection and propagation of ultrasonic waves through the flow medium. However, this system involves two transducers, one transmitter and one receiver on opposite sides of the pipeline. In addition, these ultrasonic sensors may require periodic calibration, the geometry of the pipe may affect the propagation of ultrasonic waves, which may limit the application of the sensors in some specific configurations. Other non-intrusive multiphase meters involve microwave and radiation principles, of restricted use and high hazard, in addition to the complex installation and maintenance.

In this context, it is observed that the state of the art lacks a method with indirect approaches to identify the two-phase flow pattern and, subsequently, estimate the parameters of intermittent flow in horizontal pipelines by means of non-invasive and non-intrusive structural vibration measurements and by means of non-invasive dynamic pressure signals. Thus, the present disclosure proposes a method and a system to identify and characterize the two-phase liquid-gas flow inside horizontal pipelines, indirectly from the analysis of structural vibration and dynamic pressure measurements. For this, physical principles of fluid-structure coupling are used to capture frequency bands in which the phenomenon of mass modulation is marked. Thus, through signal analysis techniques, it is possible to identify the flow pattern and estimate its characteristics such as velocity and frequency in intermittent patterns using structural vibration signals. The method and system claimed are simple, and the acceleration and pressure sensors are easily acquired commercially, in addition to being easy to fix and maintain. In addition, the methodology developed specifically does not require external excitation mechanisms, facilitating its application in sites of difficult access.

### STATE OF THE ART

Document BR1020210244283 discloses a method and system for measuring characteristics of a multiphase flow from structural vibration signals. In this sense, the objectives of the disclosure are achieved through a method for measuring characteristics of a multiphase flow from structural vibration signals that comprises: obtaining, by means of acceleration sensors (V01, V02, T00) fixed externally to a pipeline, signals based on the vibration of the internal flow of the pipe; processing, by means of a processing device, the signals obtained; and determining a dispersion curve adjustment coefficient to determine the void fraction of the mixture.

Differently from document BR1020210244283, the present disclosure estimates distinct parameters, the approaches of document BR1020210244283 employ completely different methodologies to achieve their objectives, highlighting that the document proposes techniques to determine the void fraction of the piston flow, while the present disclosure proposes techniques to estimate the flow pattern, including frequency and velocity characteristics of the piston pattern.

Document EP1886098B1 refers to an apparatus for measuring a parameter of a process flow passing inside a pipe and, more particularly, to a flow measuring apparatus with ultrasonic sensors and an array of sensors based on strain and for processing data signals coming from them to provide an output indicative of the speed of sound propagating through the process flow and/or a flow parameter of the process flow passing through a tube.

Differently from document EP1886098B1, which in addition to describing different methodologies from the present disclosure, presents a difference in the estimated parameters and sensors used. While the present disclosure proposes techniques for estimating the flow pattern, covering characteristics such as frequency and velocity of the piston pattern, the document EP1886098B1 uses ultrasonic sensors to estimate the speed of sound and fraction and void.

Document US20100198531A1 shows a vibrating flow meter to measure the flow characteristics of a three-phase flow. The vibrating flow meter includes a meter assembly including capture sensors and measurement electronic components coupled to the capture sensors. The meter electronics are configured to receive a vibrational response from the capture sensors, generate a first three-phase flow density measurement using a first frequency component of the vibrational response, and generate at least a second density, three-phase flow measurement using at least a second frequency component of the vibrational response. The at least second frequency component is a different frequency than the first frequency component. The meter electronics are further configured to determine one or more flow characteristics of the first density measurement and at least the second density measurement.

However, it is important to note that, unlike the present disclosure, the system from document US20100198531A1 faces significant challenges regarding its applicability in industrial environments. Since changes in the pipeline designs are required to be used, it also generates a large load loss in the system and may not be suitable for extreme working conditions. Thus, its installation complexity is a relevant obstacle, and the methodologies employed to estimate the characteristics of the fluid are different from the present disclosure. Finally, it is important to highlight the distinction between the characteristics estimated by document US20100198531A1, which include densities, speed of sound, phase fractions, watercut and vibrational frequencies. On the other hand, the present disclosure offers techniques for estimating the flow pattern, covering elements such as passage frequency and speed of the piston pattern.

Document US20030010126A1 refers to a non-intrusive method for characterizing flow disturbances of a fluid within a cylindrical tube. According to the disclosure, to determine flow disturbances, the method consists of using the variation in fluid pressure as the first indicator: by placing at least one fixation collar around the tube, the collar being equipped with at least one strain sensor sensitive to the strain to which the pipe is subjected due to variations in fluid pressure; measuring the strain variations detected by the strain sensor; and determining the variations in fluid pressure inside the tube from measurements of deformation variations detected by said sensor.

Specifically, document US20030010126A1 emphasizes the possibility of using flow-induced vibration to obtain characteristics of the same, however it does not describe which techniques should be used or which characteristics can be obtained, being different from the present disclosure.

The non-patent document “Two-Phase Mass Flow Measurement Using Noise Analysis” applies the analysis of vibration signals to estimate the mass flow from their standard deviation. On the other hand, in the present disclosure, the volumetric flow can be obtained indirectly for piston pattern flows, in which case the method proposed in the document “Two-Phase Mass Flow Measurement Using Noise Analysis” comprises significant errors.

The non-patent document “Elongated bubble velocity estimation in vertical liquid-gas flows using flow induced vibration” uses accelerometers to estimate the translation velocity of elongated bubbles in vertical flows.

Differently from the non-patent document “Elongated bubble velocity estimation in vertical liquid-gas flows using flow induced vibration”, the present disclosure presents a methodology for demodulation of acceleration signals based on the principle of fluid-structure coupling, in addition to estimating more parameters such as velocity and identifying the flow pattern.

The non-patent document “Flow pattern classification in water-air vertical flows using a single ultrasonic transducer” proposes a method of flow pattern classification using an ultrasonic sensor, determining a threshold to identify the flow pattern in vertical pipelines.

However, differently from the present disclosure, the only threshold used in the non-patent document “Flow pattern classification in water-air vertical flows using a single ultrasonic transducer” is based on signal energy, which results in a lack of dimensionlessness. This compromises the quality of the estimate, as it is challenging to identify transition patterns with only one threshold. By contrast, in the proposed disclosure, all thresholds are dimensionless, forming a map of flow patterns that capture the dynamics of the system, including patterns and transitions. In addition, the threshold of the present disclosure is different as they encompass Hurst's exponent and Pearson's and Spearman's coefficients for the acceleration signals and Hurst's exponent, Lyapunov and correlation dimension coefficient for the pressure signals.

In the non-patent document “Flow pattern classification in liquid-gas flows using flow-induced vibration” the use of acceleration signals to classify the flow pattern is demonstrated, however, differently from the method proposed in the present disclosure, only two criteria are used: RMS and Pearson's correlation coefficient, that is, a dimensional parameter (RMS) is used, which may depend on local settings. Furthermore, the signals are filtered at empirically determined frequencies, while the present disclosure proposes an analytical method to determine these frequencies.

The non-patent document “Dispersed-phase velocities for gas-liquid vertical slug and dispersed bubbles flows using an ultrasonic cross-correlation technique” proposes the use of ultrasound signals to calculate the translation velocity of dispersed phases in dispersed bubble pattern and piston flows. It is noted that the signal is obtained by an ultrasonic sensor, while in the method of the present disclosure accelerometers/acceleration sensors are used.

In this context, it is observed that the state of the art lacks a method with indirect approaches to identify the two-phase flow pattern and, subsequently, to estimate the parameters of intermittent flow in horizontal pipelines through non-invasive and non-intrusive structural vibration measurements and through non-invasive dynamic pressure signals. Thus, the present disclosure proposes a method and a system to identify and characterize the two-phase liquid-gas flow inside pipes, indirectly from the analysis of structural vibration and dynamic pressure measurements. For this, physical principles of fluid-structure coupling are used to capture frequency bands in which the phenomenon of mass modulation is marked. Thus, through signal analysis techniques, it is possible to identify the flow pattern and estimate its characteristics such as speed and frequency in intermittent patterns. The method and system are simple, and the acceleration and pressure sensors are easily acquired commercially, in addition to being easy to fix and maintain. In addition, the methodology developed does not require external excitation mechanisms, facilitating its application in sites of difficult access.

### SUMMARY OF THE DISCLOSURE

The present disclosure proposes a system for measuring horizontal gas-liquid two-phase flow characteristics based on signals from piezoelectric pressure sensors and structural vibration, comprising: acceleration sensors (Ac1, Ac2, Ac3, Ac4 and Ac5); pressure sensors (Pre1, Pre2, Pre3,

Pre4, Pre5, Pre6, Pre7, Pre8, Pre9, Pre10); wherein an acceleration sensor (Ac1, Ac2, Ac3, Ac4, and Ac5) calculates a first and second frequency of cut-on of a pipe, then a signal is demodulated into a first and second frequency of cut-on, and dimensionless coefficients are calculated from a 3D map created identifying a flow pattern. In addition, the acceleration sensors (Ac1, Ac2, Ac3, Ac4 and Ac5) are non-invasive and non-intrusive sensors, and the pressure sensors (Pre1, Pre2, Pre3, Pre4, Pre5, Pre6, Pre7, Pre8, Pre9, Pre10) are non-intrusive. In addition, the cut-on frequencies of the pipe are calculated using an analytical expression. In which a pressure signal (Prn) is acquired and is subsequently decimated at 50 Hz. Additionally, from the non-invasive or non-intrusive sensors, an acquisition of pressure and vibration time series is performed, in which subsequently a signal processing is performed by multi-domain models and in-situ fluid properties fluid, such as velocity, frequency are obtained. In addition, the system identifies a flow pattern using a pressure sensor (Pre1, Pre2, Pre3, Pre4, Pre5, Pre6, Pre7, Pre8, Pre9, Pre10) comprising first filtering the signal with a zero-phase low-pass filter at 50 Hz, then reconstructs a state space and calculates the dimensionless correlation dimension coefficient and Lyapunov exponent, where a Hurst coefficient is already calculated directly from a filtered time series.

In addition, the present disclosure refers to a method of measuring the characteristics of horizontal gas-liquid two-phase flows for a system, as defined above, characterized in that it comprises: (a) identifying a flow pattern and characterizing an intermittent pattern from structural pressure and vibration signals; (b) analyzing the effects of two-phase flow in pipelines; (c) estimating a translational velocity using demodulated pressure and acceleration signals; (d) estimating a frequency using demodulated pressure and acceleration signals; and (e) demodulating the structural vibration signals based on a fluid-structure coupling mechanism, initially comprising a filtering of the signal at the cut-off frequency and then the obtainment of an envelope by the Hilbert transform method. In which in step (a) the characterization of an intermittent flow is done in terms of slug velocity and frequency. In addition, in step (a) the identification of a flow pattern includes the use of an acceleration sensor (Ac1, Ac2, Ac3, Ac4 and Ac5) or a pressure sensor (Pre1, Pre2, Pre3, Pre4, Pre5, Pre6, Pre7, Pre8, Pre9, Pre10). In addition, in step (d) a slug frequency is calculated from acceleration and/or pressure signals. Additionally, in step (c) a translation velocity of a slug is calculated from the acceleration and/or pressure signals.

### DESCRIPTION OF THE DRAWINGS

In the state of the art, there are solutions of methods and systems to measure characteristics of a multiphase flow from structural vibration signals. The distinctive feature of the present disclosure is to present a method and a system for identification and characterization of two-phase liquid-gas flow using structural vibration and pressure sensors, with the absence of external excitation mechanisms. Therefore, the present disclosure will be described below with reference to the typical embodiments thereof and also with reference to the attached drawings, wherein:

FIG. 1 is a representation of a schematic of the test section in the experimental apparatus, in which the positions and distances of the pressure sensors, acceleration sensors, and fraction of voids are indicated by d, as well as the visualization section where the high-speed camera was positioned, according to an embodiment of the present disclosure.

FIG. 2 is a representation of a general scheme of the method of identifying the flow pattern and characterizing the intermittent pattern from structural pressure and vibration signals, according to an embodiment of the present disclosure.

FIG. 3 is a representation of the power spectral density (PSD) of the acceleration signals (black line) for point 13 of the experimental matrix, where the analytical cut-on frequencies are highlighted: fₙ₁ (red dashed line), fₙ₂ (green dashed line) and fₙ₃ (pink dashed line), according to an embodiment of this disclosure.

FIG. 4 is a representation of the range of the frequency response function (FRF) (red line) and ordinary coherence function for experimental point 13, according to an embodiment of this disclosure.

FIG. 5 is a representation of a scheme of the claimed method for identifying the flow pattern using only an acceleration sensor, where the cut-on frequencies of the pipe are first calculated using an analytical expression, followed by signal demodulation, and finally, the dimensionless thresholds/coefficients: Pearson, Spearman, and Hurst, are calculated, according to an embodiment of the present disclosure.

FIG. 6 is a representation of the Hurst exponents calculated from the demodulated acceleration measurements for all 23 experimental points of the test matrix, where each bar represents an acceleration sensor sequentially: A_{c1}, A_{c2}, A_{c3}, A_{c4} and A_{c5}, and each color represents a flow pattern: red for smooth stratified (SS), green for wavy stratified (SW), blue for slug (SL) and yellow for scattered bubbles (DB), according to an embodiment of the present disclosure.

FIG. 7 is a representation of a Pearson's coefficient (ρ) (a) and Spearman's coefficient (ζ) (b) calculated between the vibration signals demodulated at the first and second cut-on frequencies, for all 23 experimental points of the test matrix, where each bar represents an acceleration sensor sequentially: A_{c1}, A_{c2}, A_{c3}, A_{c4} and A_{c5}, and each color represents a flow pattern: red for smooth stratified (SS), green for wavy stratified (SW), blue for slug (SL) and yellow for scattered bubbles (DB), according to an embodiment of the present disclosure.

FIG. 8 is a representation of a three-dimensional flow pattern map: Pearson's coefficient (ρ), Spearman's coefficient (ζ) and Hurst's exponent (h), calculated from the demodulated acceleration signals from all 23 experimental points to all sensors, wherein each symbol represents a pressure sensor from A_{c1} to A_{c2}, and each color represents a flow pattern: red for smooth stratified (SS), green for wavy stratified (SW), blue for slug (SL) and yellow for scattered bubbles (DB), according to an embodiment of the present disclosure.

FIG. 9 is a representation of a scheme of the claimed method of identifying flow pattern using a pressure sensor, comprising first filtering the signal with a zero-phase low-pass filter at 50 Hz, then reconstructing the state space and then calculating the dimensionless correlation dimension coefficient and Lyapunov exponent, and the Hurst coefficient is already calculated directly from the filtered time series, according to an embodiment of the present disclosure.

FIG. 10 is a representation of a value of the Hurst's exponent (h) calculated from the pressure time series, for all 23 experimental points of the test matrix and sensors, wherein the values are grouped together with ten vertical bars, each bar being a sensor, sequentially distributed from Pᵣₑ₁ to Pᵣₑ₁₀, and each color represents a flow pattern: red for smooth stratified pattern (SS), green for wavy stratified pattern (SW), blue for slug (SL) and yellow for scattered bubbles (DB), according to an embodiment of the present disclosure.

FIG. 11 is a representation of values of the Lyapunov exponent (λ) (a) and correlation dimension coefficient (c) (b) calculated from the pressure signals of all 23 experimental points for all sensors, wherein the values are grouped together with ten vertical bars, each bar being a sensor, sequentially distributed from Pᵣₑ₁ to Pᵣₑ₁₀, and each color represents a flow pattern: red for smooth stratified pattern (SS), green for wavy stratified (SW), blue for slug (SL) and yellow for scattered bubbles (DB), according to an embodiment of the present disclosure.

FIG. 12 is a representation of a three-dimensional flow pattern map: correlation dimension coefficient (c), Lyapunov exponent (A) and Hurst's exponent (h), calculated from the pressure signals from all 23 experimental points for all sensors. Each symbol represents a pressure sensor from Pᵣₑ₁ to Pᵣₑ₁₀, and each color represents a flow pattern: red for smooth stratified (SS), green for wavy stratified (SW), blue for slug (SL) and yellow for scattered bubbles (DB), according to an embodiment of the present disclosure.

FIG. 13 is a representation of a scheme of step d of the method claimed to calculate the slug frequency from the acceleration signals, according to an embodiment of the present disclosure.

FIG. 14 is a representation of the power spectral density of the void fraction (black line) and that of the demodulation acceleration signal (blue line), according to an embodiment of the present disclosure.

FIG. 15 is a representation of an estimate of slug frequency from the demodulated acceleration measurement f_{slug}−Acc env (black dots) and the void fraction signals f_{slug}−α (blue line), for each experimental slug point, according to an embodiment of the present disclosure.

FIG. 16 is a representation of a scheme of step d of the method claimed to calculate the slug frequency from the pressure signals, according to an embodiment of the present disclosure.

FIG. 17 is a representation of an estimate of slug frequency from the pressure measurement f_{slug}, pressure (black dots) and the void fraction signals f_{slug}, resistive (blue line) for each experimental slug point, according to an embodiment of the present disclosure.

FIG. 18 is a representation of a scheme of step c of the method claimed to estimate translational velocity using two demodulated acceleration signals, according to an embodiment of the present disclosure.

FIG. 19 is an estimated representation of the slug velocity from the demodulated acceleration measurements V_{TB}−A_{cc env} (black dots) and the void fraction measurements V_{TB}−α, for each experimental point in the intermittent pattern, according to an embodiment of the present disclosure.

FIG. 20 is a representation of a scheme of step c of the method claimed to estimate translational velocity using four pressure signals, according to an embodiment of the present disclosure.

FIG. 21 is a representation of an estimate of the slug velocity from the V_{TB}−Pᵣₑ pressure measurements (black dots) and the VTB−α void fraction measurements, for each experimental point in the intermittent pattern, according to an embodiment of the present disclosure.

### DETAILED DESCRIPTION OF THE DISCLOSURE

Specific embodiments of this disclosure are described below. In an effort to provide a concise description of these embodiments, all features of an actual implementation may not be described in the specification. It should be noted that, in the development of any real implementation, as in any engineering project, numerous specific implementation decisions must be made to achieve the specific objectives of the developers, such as compliance with the execution of the steps of the claimed method and the interconnection of the elements of the system for measuring horizontal gas-liquid two-phase flow characteristics based on signals from piezoelectric pressure sensors and structural vibration, which can vary from one implementation to another.

The present disclosure relates to indirect approaches to identify the two-phase flow pattern and, subsequently, to estimate the parameters of piston flow in horizontal pipelines through non-invasive and non-intrusive structural vibration measurements and through non-invasive dynamic pressure signals. The present disclosure presents a solution for the identification and characterization of two-phase liquid-gas flow inside pipes, indirectly from the analysis of structural vibration and pressure measurements. For this, physical principles of fluid-structure coupling are used to capture frequency bands in which the phenomenon of mass modulation is marked. Thus, through signal analysis techniques, it is possible to identify the pattern and estimate characteristics such as speed and frequency in piston patterns. The methods and system claimed are simple, and the acceleration and pressure sensors are easily acquired commercially, in addition to being easy to fix and maintain. And the methodology and system claimed do not have the need for external excitation mechanisms, facilitating the use in places of difficult access.

Specifically, the present disclosure presents a method that is intended to analyze the effects of two-phase flow in pipelines, and one of the sensors used are the vibration sensors fixed on the external face of the pipeline. With this in mind, a method is provided to identify the flow pattern and characterize the intermittent flow in terms of slug velocity and frequency. For this, when structural vibration signals are used, frequency bands are sought where the fluid-structure coupling phenomenon is marked. These frequencies can be calculated

$${Ω}_{n}^{2} = {( \frac{λ}{\sqrt{12} r} )}^{2} {n}^{4} [ 1 - \frac{1}{2} ( \frac{1}{1 - ν} ) ( \frac{4 - ν}{{n}^{2}} - \frac{2 + ν}{{n}^{4}} ) ] , \qquad ( 1 )$$

analytically through the expression proposed by Fahy [1]:
wherein n^{th}, h, r, v, E and p are respectively the order of the circumferential mode, thickness, pipe radius, Poisson coefficient, modulus of elasticity and mass density. And the dimensionless: Ω=\hat{ω}/ω₁eω₁=\sqrt{E/ρr²}.

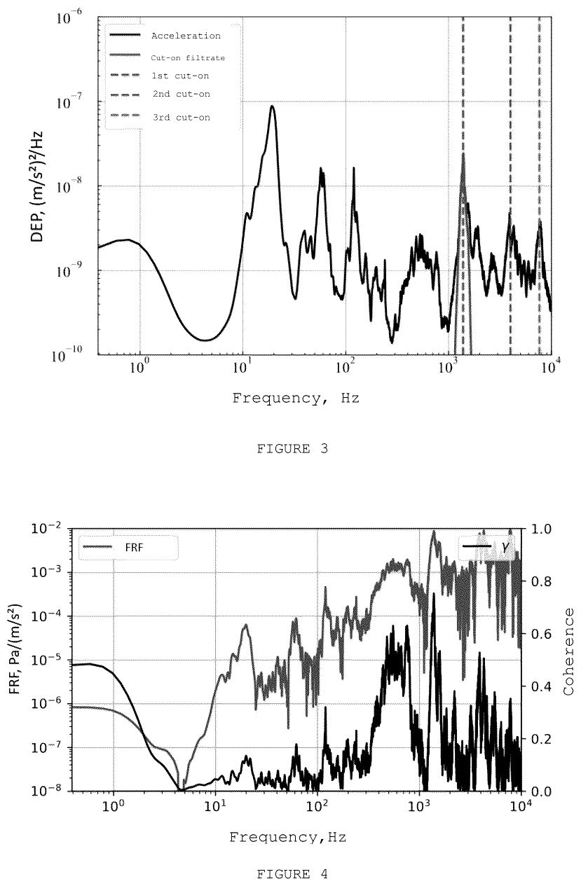

As seen in FIG. 3, the power spectral density (PSD) of the acceleration signals (black solid line) for experimental point 13. The vertical dashed lines represent the cut-on frequencies, or cut-on, analytically calculated using the expression 1. It is observed that there is an amplitude increase in the PSD close to the cut-off frequencies, showing that the above expression is a good approximation, although it is derived for empty pipes.

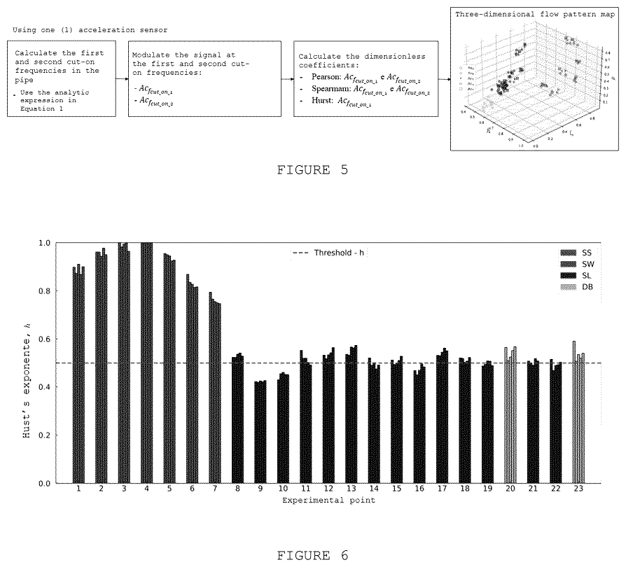

The fluid-structure coupling was investigated experimentally using structural pressure and vibration signals, in which it showed a coupling due to the wavemode deviation and the gyroscope coupling. As seen in FIG. 4, the frequency response function (FRF) of the estimator H_{T} and the coherence function y (w) between the pressure and acceleration signals are measured at the same point. It is observed that coherence levels increase markedly at cut-on frequencies and in a frequency band just above 1 kHz. However, a method of demodulation of structural vibration signals based on the fluid-structure coupling mechanism is used, in which the first step is to filter the signal at the cut-on frequency followed by envelope extraction using the Hilbert transform method. It is important to note that the center frequency of the bandpass filter used is analytically calculated by the expression 1 mentioned above.

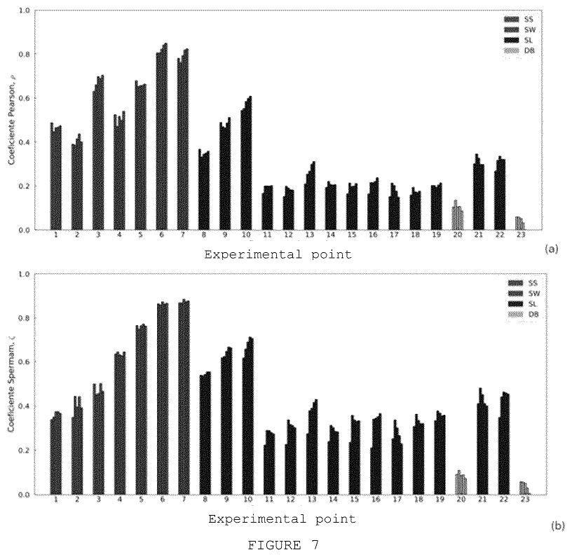

Regarding the procedure for identifying the flow pattern using the time signature of only one acceleration sensor, the first step in the identification of the system is the classification of the flow pattern using the time series of demodulated vibration. As seen in FIG. 5, a schematic illustrates the process of sorting the flow pattern using the acceleration signals. Thus, the first step is to calculate the cut-on frequencies using expression 1, which take into account only the properties and geometry of the structure. Next, the signal is demodulated into two distinct cut-on frequencies, f₁ and f₂. Then, the classifiers, Pearson's and Spearman's exponents are calculated between the A_{cf1} and A_{cf2} signals, while the Hurst exponent is calculated directly from the signal A_{cf1}. Finally, the three-dimensional flow pattern map is generated, as can be observed, this procedure is systematized in FIG. 5.

The first threshold calculated was the Hurst's exponent, which is a measure of long-range dependence or roughness of the time series, and it is the slope coefficient of the following Equation 2. If the exponent has values less than 0.5, the process is anti-persistent and has short-term memory, which means that the values observed in the time series usually change from relatively high values to relatively low values. This oscillatory behavior is typical of intermittent flow patterns, which vary between Taylor bubble and liquid piston. On the other hand, if it has a Hurst's exponent greater than 0.5, it means that it has long-term memory, also called persistence, which means that its past increments influence future ones, and the process tends to maintain the signal of increments. Typical behaviors of flows in stratified patterns, where a continuous loading is applied to the system. As it is seen in FIG. 7(a) which presents the values of the Hurst's coefficient of all experimental points in the test matrix, calculated using the rescaling technique. It is possible to observe that the values of the stratified points correspond to values greater than 0.5<h<1, which means that the series is persistent. This means that the system in the stratified pattern does not have large oscillations, maintaining its characteristic of almost constant excitation to the system. In contrast, for the intermittent patterns and scattered bubbles, the values of the Hurst's exponent are very close to 0.5, which corresponds to a random behavior, similar to Brownian motion.

$$( \frac{\text{?}}{S} ) \text{?} ∝ \text{?} , \qquad ( 2 )$$

$$\text{?} \text{indicates text missing or illegible when filed}$$

Pearson's coefficient (ρ) is a parametric measure that evaluates the linear relationship between two variables, while Spearman's coefficient (ζ) is a non-parametric measure that evaluates the monotonic association between two variables. Both coefficients range from −1 to 1, where −1 indicates a perfect negative correlation, 1 indicates a perfect positive correlation, and 0 indicates no correlation. As observed in FIG. 7, the result of the calculation of the Pearson's coefficient (ρ) (a) and the Spearman's coefficient (ζ) (b) for all experimental points of the test matrix, as well as in the previous results, each vertical bar represents a sensor, totaling five, and the colors are the flow pattern identified by the video. The two variables in this case are the acceleration signals demodulated into two typical structural frequencies, they are the first and second cut-on frequencies. It is observed that, in all cases, the values are positive, which means positive correlations, that is, they indicate that both variables move in the same direction. However, for the scattered bubbles pattern, the coefficient is very close to zero, indicating that there is no association between the two variables. However, it is possible to observe that the patterns were correctly separated, the SS and SW patterns with higher values of ρ and DB with values close to zero.

As it is seen in FIG. 8, a three-dimensional map of flow pattern classification extracted from the demodulated vibration signals, which include the Hurst's exponent, Pearson's coefficient, and Spearman's coefficient. As the test matrix has 23 experimental points and the bench has 5 acceleration sensors, it was possible to test 115 points using these techniques. The colors indicate the flow pattern observed in the footage and the symbol indicates each sensor on the bench. It is possible to observe the presence of several clusters of points with the same flow patterns. The smooth and wavy stratified patterns are very close to each other and far from the slug pattern clustering. In addition, the scattered bubbles pattern is also well grouped and separated from the other patterns.

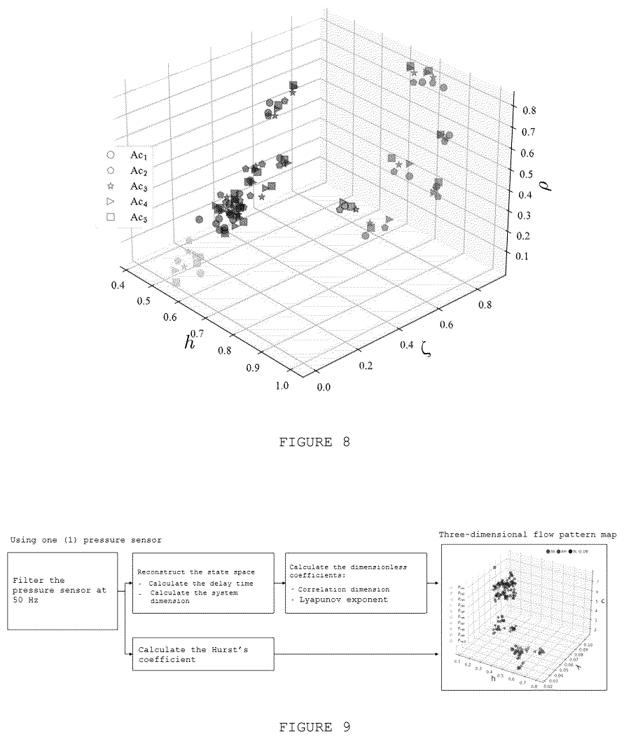

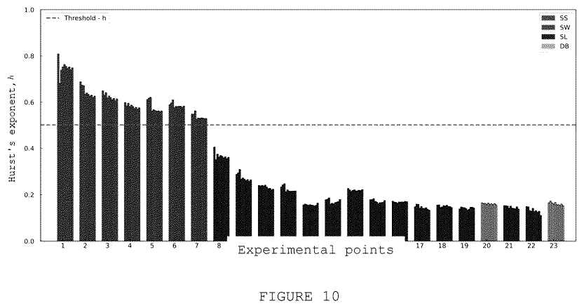

In addition, as seen in FIG. 9, a method of flow pattern classification using pressure signals, in which the first step is to filter all signals at 50 Hz, using a zero-phase Butterworth low-pass filter. Thus, the first coefficient can be calculated directly, which is the Hurst's coefficient. For the other classifiers, analysis techniques and nonlinear series were used, in which the correlation dimension and the Lyapunov exponent are calculated from the reconstructed state space. This state space is reconstructed using Takens embedding methodology, while the delay time is calculated using the mutual information function, and the dimension is estimated using the Broomhead method. A three-dimensional flow pattern is then map constructed. Finally, as in the previous case, the three-dimensional pattern map is assembled with the three dimensionless coefficients calculated.

As in the previous case, the R/S rescaling (Range over Standard Deviation) technique was used to calculate the Hurst's exponent (h) for the pressure signals. As seen in FIG. 10, the value of h for each point in the test matrix for all the pressure sensors. The results are grouped by experimental point, and each vertical bar represents a pressure sensor, sequentially distributed from Pᵣₑ₁ to Pᵣₑ₁₀. It is observed that the values of the stratified points are between 1>h>0.5, which means that the series is persistent. As for the intermittent patterns, the h values are between 0<h<0.5, which corresponds to an anti-persistent series. This is linked to the oscillatory behavior of this pattern varying between the liquid piston and the Taylor bubble, and consequently, the exponent value was below 0.2 for most points of the slug pattern. However, observed that for the experimental points P8 and P9, the values of h are slightly higher than the other points of the slug pattern, but still below 0.5. At these points, the Taylor bubble region is larger, meaning there is a higher occurrence of the stratified region.

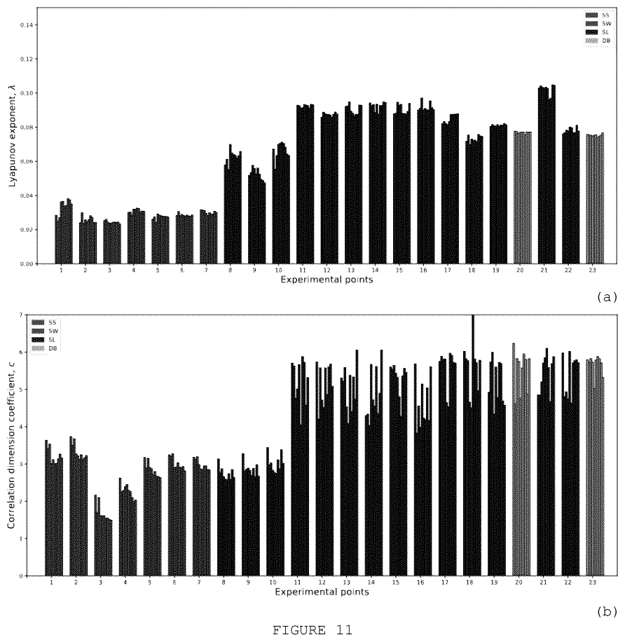

As seen in FIG. 11(a) which shows the values of the Lyapunov exponent (λ) of each experimental point, it is observed that the intermittent patterns have a value of A higher than the other patterns. This exponent is calculated using the following Equation 3. Thus, the maximum value of the Lyapunov exponent is given by the slope of the first part of the S₍ₖ₎ curve versus k. The correlation dimension coefficient (c) is a measure that describes the geometric complexity of a dynamical system, also known as the fractal correlation dimension or generalized correlation dimension. And this is calculated using the following Equation 4, where the correlation coefficient is the slope of the curve CD versus c. As seen in FIG. 11(b), the estimate of c for all sensors and all points in the test matrix. It is possible to observe that the coefficient is less than 4 for smooth and wavy stratified points. For the intermittent and dispersed bubble points, the coefficient is higher, indicating greater complexity in the dynamics. That is, the higher the coefficient, the greater the fractal dimension, indicating greater complexity in the chaotic behavior in the system.

$$S ( k ) = \frac{1}{N} \text{?} ln ( \frac{1}{‖ U \text{?} ‖} \text{?} ‖ \text{?} - \text{?} ‖ ) , \qquad ( 3 )$$

$$CD ( \text{?} ) = \frac{2}{( N - n \text{?} ) ( N - {n}_{min} - 1 )} {\sum }_{i = 1}^{N} {\sum }_{j = i + 1}^{N} \text{?} ( \text{?} - ‖ \text{?} - \text{?} ‖ ) . \qquad ( 4 )$$

$$\text{?} \text{indicates text missing or illegible when filed}$$

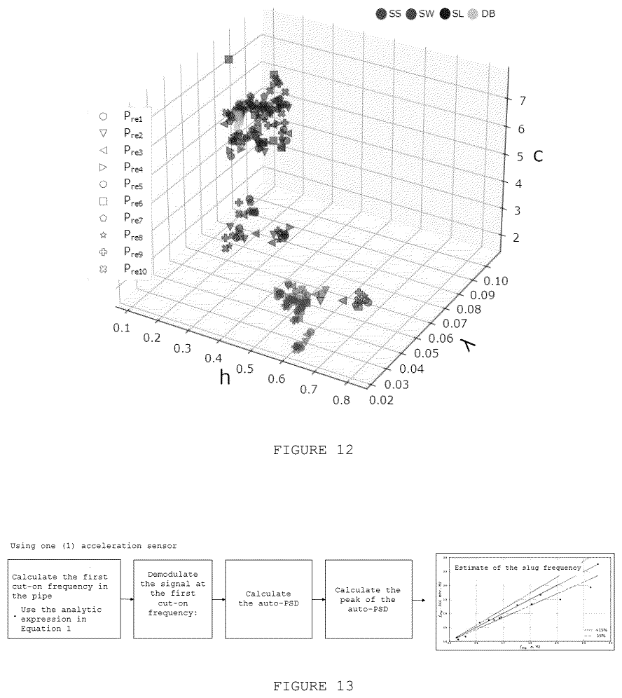

The dimensionless parameters of Hurst's exponent (h), correlation dimension coefficient (c) and Lyapunov exponent (λ) are observed in FIG. 12. For this purpose, the 10 pressure sensors and the 23 experimental points were used, i.e., a total of 230 time series were tested. observed that a clustering of points with the same flow patterns is clearly formed, and the points from different sensors of the same experimental run are consistently close to each other. Thus, the stratified-smooth and stratified-wavy patterns are very close and well distanced from the cluster of the slug pattern. The points P8, P9 and P10 are between the stratified and slug patterns, as the passage frequency is low, and consequently, the Taylor bubble is longer. These points can also be classified as transition points. In addition, the cluster of scattered bubbles is closer to the cluster of the slug pattern, which is expected since the latter also has scattered bubbles in the liquid piston. This indicates that clustering has physical significance due to the choice of dimensionless parameters.

Once the experimental series is identified as intermittent pattern, some characteristics are estimated, such as: slug frequency and translational velocity. Regarding the procedure for estimating the slug frequency using the temporal signature of only one acceleration sensor and two pressure sensors, the number of slug units that passed through a fixed point in the pipe during a specific time, i.e., the slug frequency f_{slug}, in step (d) of the claimed method, is estimated from the demodulated signals using the acceleration signals. Thus, like the other characteristics of the intermittent pattern, f_{slug} is an essential parameter that, in some cases, can cause a number of operational problems, especially when the frequency is high. As observed in FIG. 13 that presents a step-by-step flowchart of how to calculate the f_{slug}, the first step is to demodulate the signal at the first cut-on frequency of the structure, whose center frequency is analytically calculated by expression 1. Next, the power spectral density (PSD) of the demodulated signal is calculated. Finally, the last step is to calculate the peak maximum amplitude of the PSD of the demodulated acceleration signal.

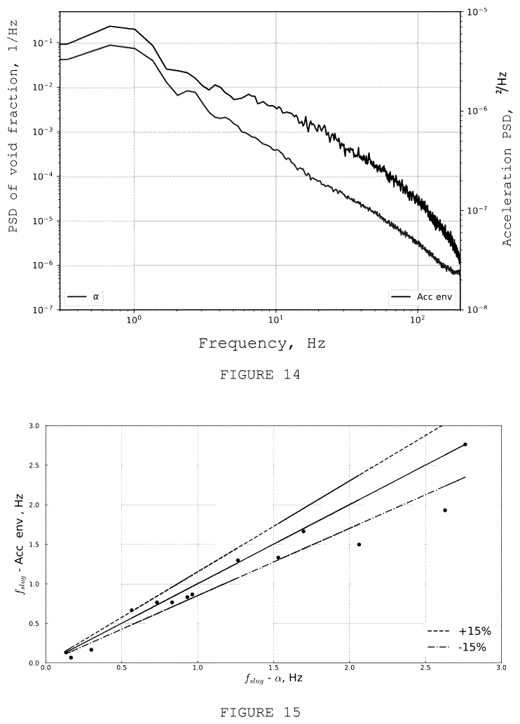

As seen in FIG. 14, the PSD of the demodulated acceleration signal is shown in blue, and the PSD of the signal and void fraction calculated from the resistive sensor. For both cases, the PSDs were calculated using the Welch method, with a number of blocks N_{sec}=20 and a Hanning window. In some cases, intermittent flow is assumed to be a stochastic process, where the peak of the PSD of the void fraction signal is a direct measure of the likely passage frequency of the unit cell, and the PSD decay rate at higher frequencies may be related to the short-term variability of the slug's unit cell. Therefore, it is observed that the content of the main frequency of the demodulated vibration response corresponds to that obtained by the fraction and void series. Thus, it is possible to estimate the passage frequency of the unit cell of the demodulated vibration signals, the result of which is shown in FIG. 15 for all the intermittent points of the pattern of the test matrix.

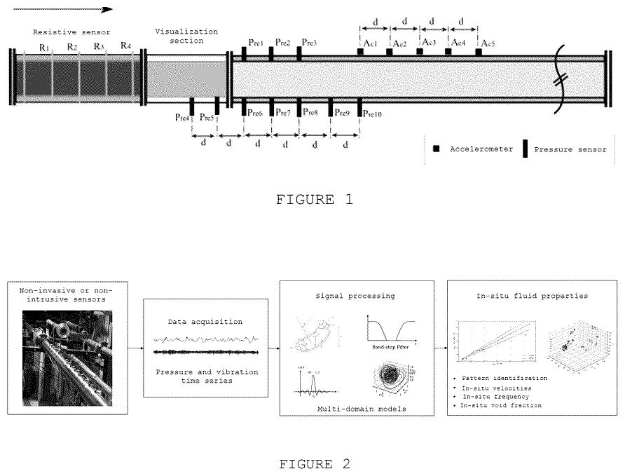

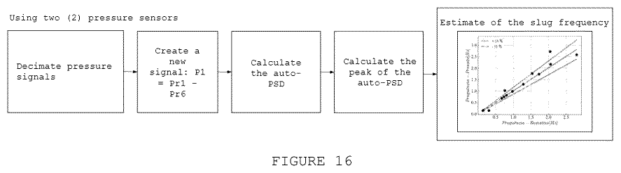

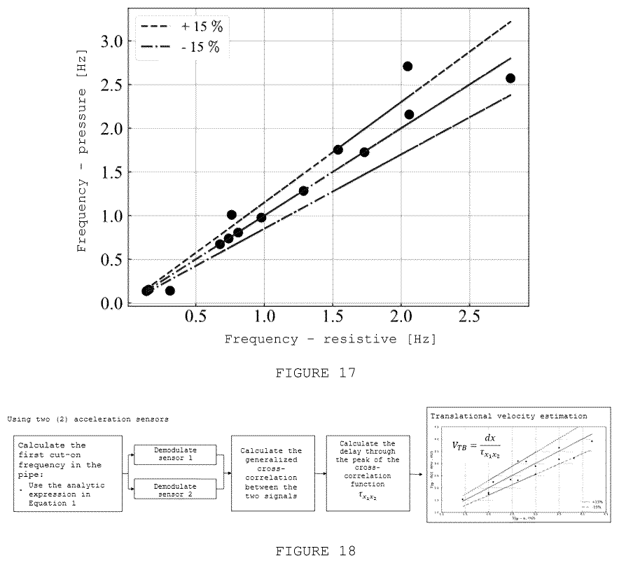

Specifically in step (d) of the claimed method, the passage frequency of the slug can be obtained using two pressure sensors, one located at the top and the other at the bottom of the pipe, for example, the sensors Pᵣ₁ and Pᵣ₆ of the test bench, as seen in FIG. 2. A pressure difference signal is created by subtracting one signal from another, then the auto PSD of that signal is calculated, and the more energetic frequency is obtained. This frequency can be related to the characteristic frequency of piston flow, as can be seen in FIG. 16. The frequency values obtained using this method are compared with the frequency values obtained using the resistive sensors, as seen in FIG. 17. It is noted that the error is less than 15% for most of the experimental points.

In an embodiment of the present disclosure, in step (c) of the claimed method, the translation velocity of the slug is estimated using two demodulated acceleration signals (x₁ and x₂) spaced by a known distance dx. Generalized cross-correlation (GCC) between the demodulated signals is used to calculate the delay time. GCC is estimated using the following equation 5, where Ψg(ω) is a frequency-weighting function and

$$R \text{?} ( \text{?} ) = {P}^{- 1} \{ \text{?} ( ω ) \text{?} S \text{?} ( ω ) \} = \frac{1}{2 π} {\int }_{∞}^{- ∞} Ψ \text{?} ( ω ) S \text{?} ( ω ) \text{?} \qquad ( 5 )$$

$$\text{?} \text{indicates text missing or illegible when filed}$$

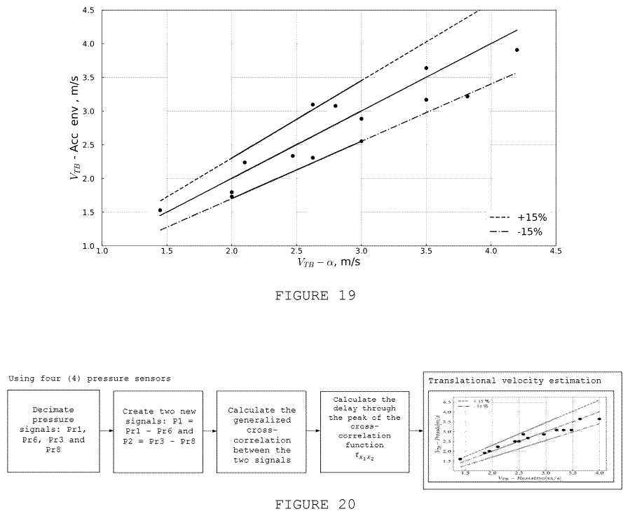

Sₓ₁ₓ₂ is the crossover spectral density. Knowing the delay time and the distance between the sensors, it is possible to estimate the translation speed, as observed in FIG. 18. As seen in FIG. 19, the estimated velocity for all intermittent pattern points of the test matrix compared to the estimates obtained by the void fraction signal, have error lines of 15%. It is observed that all measurements are within the error range, indicating a good agreement between the measured and expected results.

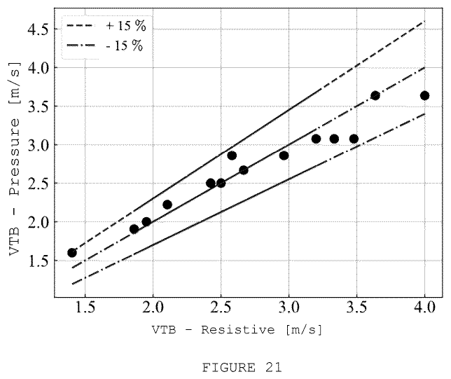

To obtain the translation velocity using the pressure sensors, 4 pressure signals are used, forming two pairs of sensors separated by a distance dₓ. Within each pair, one sensor is located in the lower region of the pipe and another in the upper region (sensors Pr1 and Pr6 in FIG. 2 form a pair). The signals are decimated up to a frequency of 100 Hz. Next, the signals from each pair are subtracted generating two new signals. In step (d) of the claimed method, the cross-correlation between these signals is calculated and the delay between the two signals is estimated through the peak of the cross-correlation, and thus, the velocity can be estimated, as observed in FIG. 20. The translational velocities for the piston points of the experimental matrix present errors of less than 15%, as seen in FIG. 21.

### Exemplary Embodiment/Tests/Results

The approaches used and the tests performed by type of sensors to estimate each parameter of interest will be presented, which are three: define flow pattern, slug frequency and translational velocity, as observed in FIG. 1.

The experimental tests were conducted at the Experimental Laboratory of Petroleum—LabPetro—of the Center for Energy and Petroleum Studies—CEPETRO—of the State University of Campinas. For the experiment, a steel pipe was used, whose properties are presented in Table 1 below, together with the properties of the two-phase mixture. The test section is 6 meters long, while the pipeline is 20 meters long before the measurement section for flow development purposes. The experimental apparatus has several sensors for synchronous measurement, as shown in FIG. 2, three PCB 112B21 piezoelectric sensors (model 1), named Pre1, Pre2 and Pre3, seven 106B50 piezoelectric sensors (model 2) Pre4, Pre5, Pre6, Pre7, Pre8, Pre9, Pre10, five PCB accelerometers/acceleration sensors 352C33, Ac1, Ac2, Ac3, Ac4 and Ac5, and a set of conductance-based flow meters with four R1, R2, R3 and R4 sensors. In the acquisition of these signals, a sampling rate of 25.6 kHz was used for the pressure and acceleration sensors and 400 Hz for the void fraction sensors. It is also possible to observe the visualization section, which corresponds to a transparent acrylic box, in which a high-speed camera (Phantom model VEO 640) has been positioned and configured for a measurement rate of 800 frames per second.

In the experimental tests, 23 points of four different flow patterns were acquired: smooth stratified (SS), wavy stratified (SW), intermittent bubbles (SL) and scattered bubbles (DB). Table 1 below details the experimental points with their respective surface velocities of liquid and gas, Jₛₗ and Jₛₗ, length of the liquid piston (L_{slug}, length of the Taylor bubble (L_{bubble}) and, finally, the flow pattern confirmed in the high-speed camera. Specifically, the following table 1 comprises a matrix of experimental tests with surface velocities of liquid (Jₛₗ), surface velocities of gas (J_{sg}), liquid piston length (L_{slug}), Taylor bubble length (L_{bubble}) and flow pattern. The flow patterns are classified as smooth stratified (SS), wavy stratified (SW), intermittent bubbles (SL) and scattered bubbles (DB).

TABLE 1
Steel pipeline properties

| | Jₛₗ | J_{sg} | Jrn | L_{slug} | L_{bubble} | Flow pattern |
|---|---|---|---|---|---|---|
| Point | [m/s] | [m/s] | [m/s] | [m] | [m] | [—] |
| 1 | 0.258 | 0.106 | 0.364 | — | — | SS |
| 2 | 0.259 | 0.202 | 0.461 | — | — | SS |
| 3 | 0.258 | 0.480 | 0.738 | — | — | SS |
| 4 | 0.258 | 0.899 | 1.157 | — | — | SW |
| 5 | 0.258 | 1.144 | 1.402 | — | — | SW |
| 6 | 0.258 | 1.821 | 2.079 | — | — | SW |
| 7 | 0.259 | 2.036 | 2.295 | — | — | SW |
| 8 | 0.580 | 0.503 | 1.083 | 3.665 | 4.851 | SL |
| 9 | 0.579 | 0.977 | 1.556 | 2.325 | 7.172 | SL |
| 10 | 0.577 | 1.431 | 2.008 | 1.640 | 8.250 | SL |
| 11 | 1.191 | 0.381 | 1.572 | 1.158 | 0.666 | SL |
| 12 | 1.315 | 0.844 | 2.159 | 0.935 | 1.332 | SL |
| 13 | 1.354 | 1.402 | 2.756 | 1.065 | 2.313 | SL |
| 14 | 1.301 | 0.492 | 1.793 | 1.035 | 0.875 | SL |
| 15 | 1.242 | 1.001 | 2.243 | 1.047 | 1.922 | SL |
| 16 | 1.210 | 1.219 | 2.429 | 1.22 | 2.476 | SL |
| 17 | 2.150 | 0.531 | 2.681 | 0.820 | 0.547 | SL |
| 18 | 2.044 | 1.016 | 3.060 | 0.841 | 0.964 | SL |
| 19 | 2.015 | 1.184 | 3.199 | 0.869 | 1.147 | SL |
| 20 | 3.154 | 0.095 | 3.248 | — | | DB |
| 21 | 3.043 | 0.420 | 3.462 | 0.670 | 0.495 | SL |
| 22 | 2.926 | 0.855 | 3.782 | 0.902 | 0.670 | SL |
| 23 | 3.328 | 0.078 | 3.406 | — | — | DB |

Based on the tests conducted, it was concluded that the present disclosure, by using indirect approaches for the identification and characterization of flow patterns, particularly intermittent patterns, has as its main advantage the elimination of subjectivity compared to traditional methods based on inspection. In addition to being potentially low-cost and easy to install, they also allow integration with other supervisory systems and the internet of things. In this context, this disclosure uses non-invasive pressure and non-intrusive acceleration sensors. For this, signal processing techniques are used in conjunction with physical models. Approaches based on time and frequency methods, such as cross-correlation, together with acoustic and structural wave propagation models, and methods based on non-linear time series analysis, such as Pearson, Spearman and Hurst exponents, are proposed.

### BIBLIOGRAPHIC REFERENCES

F. FAHY, P. GARDONIO, Sound and Structural Vibration Radiation, Transmission and Response, Academic Press in an imprint of Elsevier, 2015.
H. Hurst, Long term storage capacity of reservoirs, Transactions of the American Society of Civil Engineers 116 (1951) 770-199.
F. Takens, Takens, F. (1981). Detecting strange attractors in turbulence. In D. Rand & L.-S. Young (Eds.), Dynamical systems and turbulence, Warwick 1980. Lecture notes in mathematics (pp. 366-381). Springer., Springer (10.1007/BFb0091924).
D. S. Broomhead, G. P. King, Extracting qualitative dynamics from experimental data (1986).
H. Kantz, T. Schreiber, Nonlinear time series analysis, 2nd edition.

1. System for measuring horizontal two-phase gas-liquid flow characteristics based on signals from one or more piezoelectric pressure sensors and structural vibration, the system comprising:
one or more acceleration sensors; and
one or more pressure sensors, and wherein the one or more acceleration sensors calculates a first and second cut-on frequency of a pipe, a signal is demodulated into a first and second cut-on frequency, and dimensionless coefficients are calculated from a three-dimensional (3D) map created to identify a flow pattern.

2. The system according to claim 1, wherein the one or more acceleration sensors comprises at least one non-invasive sensor and at least one non-intrusive sensor, and the one or more pressure sensors comprises at least one non-intrusive sensor.

3. The system according to claim 1, wherein the cut-on frequencies of the pipe are calculated via an analytical expression.

4. The system according to claim 1, wherein a pressure signal is acquired, and is subsequently decimated at 50 Hz.

5. The system according to claim 2, wherein the at least one non-invasive sensor or the at least one non-intrusive sensor is used to acquire time series of pressure and vibration, wherein signal processing is then performed using multi-domain models, and wherein in-situ fluid properties, including velocity and frequency, are obtained.

6. The system according to claim 5, wherein the system identifies a flow pattern by use of the one or more pressure sensors, and wherein the identifies step comprises first filtering the signal with a zero-phase low-pass filter at 50 Hz, then reconstructing a state space and calculating the dimensionless correlation dimension coefficient and Lyapunov's exponent, and wherein a Hurst coefficient is calculated directly from a filtered time series.

7. Method of measuring the characteristics of horizontal two-phase gas-liquid flows for a system, as defined in claim 1, comprising:
(a) identifying a flow pattern;
(b) characterizing an intermittent pattern from structural pressure and vibration signals;
(c) analyzing the effects of two-phase flow in pipelines;
(d) estimating a translational velocity by use of demodulated pressure and acceleration signals;
(e) estimating a frequency by use of demodulated pressure and acceleration signals; and
(e) demodulating the structural vibration signals based on a fluid-structure coupling mechanism, the demodulating comprising filtering of the signal at the cut-off frequency and then the obtaining an envelope by the Hilbert transform method.

8. The method according to claim 7, wherein for step (b), the characterization of an intermittent flow is done in terms of slug velocity and frequency.

9. The method according to claim 7, wherein for step (a), the identification of a flow pattern includes the use of the one or more acceleration sensors or the one or more pressure sensors.

10. The method according to claim 7, wherein for step (e), a slug frequency is calculated from acceleration and/or pressure signals.

11. The method according to claim 7, wherein for step (d), a slug translation velocity is calculated from the acceleration and/or pressure signals.
